(19) United States
(12) Patent Application Publication
(10) Pub. No.: US 2026/0356090 A1
(43) Pub. Date: Nov. 12, 2026

(54) DROPLET DISCHARGE DEVICE AND METHOD FOR DRIVING DROPLET DISCHARGE DEVICE

(71) Applicant: Konica Minolta, Inc., Tokyo (JP)

(72) Inventor: Masanori SHIMAZOE, Hino-shi, Tokyo (JP)

(21) Appl. No.: 19/515,338

(22) PCT Filed: Jul. 31, 2024
(86) PCT No.: PCT/JP2024/027330

§ 371 Date: Feb. 27, 2026

(30) Foreign Application Priority Data
Sep. 4, 2023 (JP) 2023-142643

(51) Int. Cl. B41J 2/045

(52) U.S. Cl. CPC B41J 2/04556; B41J 2/04581; B41J 2/04588; B41J 2/04591

(57) ABSTRACT

A droplet discharge device 1 is provided with: an acquisition unit that acquires a distance L between a recording medium M and a droplet discharge head 23; an adjustment unit that expands or contracts a pulse width of a common drive waveform P00 on the basis of the distance L; a determination unit that selects one or more drive pulses corresponding to sizes of droplets from the common drive waveform P01 adjusted by the adjustment unit to determine a discharge drive pulse; and a discharge control unit that causes the nozzles 21 to discharge droplets of a plurality of sizes using a plurality of discharge drive pulses determined by the determination unit.

### TECHNICAL FIELD

The present invention relates to a droplet ejection apparatus and a method of driving the droplet ejection apparatus.

### BACKGROUND ART

Conventionally, a droplet ejection apparatus that ejects droplets onto a recording surface of a recording medium to record an image has been known. In the droplet ejection apparatus, droplets are ejected from nozzles of a droplet ejection head at appropriate timings, based on image data.

As such a droplet ejection apparatus, for example, Patent document 1 describes an invention of aligning the landing positions of droplets having different sizes ejected in response to multiple drive pulses.

### CITATION LIST

### Patent Literature

Patent Document 1: Japanese Unexamined Patent Application Publication No. 2007-144659

### SUMMARY OF INVENTION

### Technical Problem

Since the droplets of different sizes have different air resistances, the droplets are ejected with different ejection speeds. When the media gap widens, the landing positions may vary depending on the difference in the ejection speeds. Patent Document 1 does not describe or suggest aligning the landing positions when the media gap has changed.

The present invention has been made in view of such circumstances. An object of the present invention is to provide a droplet ejection apparatus and a method of driving the droplet ejection apparatus that can align landing positions of droplets having different sizes even when the medium gap changes.

### Solution to Problem

In order to solve the above-described problem, the invention according to claim 1 is a droplet ejection apparatus including: a droplet ejection head that ejects droplets having multiple sizes from a nozzle by using a common drive waveform and thereby performs a recording operation on a recording medium, the common drive waveform including multiple drive pulses in a drive cycle; an acquisition section that acquires a distance between the recording medium and the droplet ejection head; an adjustment section that expands or contracts a pulse width of the common drive waveform, based on the distance; a determination section that selects one or more drive pulses corresponding to a droplet size from the common drive waveform adjusted by the adjustment section and determines a plurality of ejection drive pulses; and an ejection controller that causes the nozzle to eject the droplets having multiple sizes by the plurality of ejection drive pulses determined by the determination section.

The invention according to claim 2 is the droplet ejection apparatus according to claim 1, further including a selection section that selects a waveform rank, based on a table in which the waveform rank is associated with the distance, wherein the adjustment section expands or contracts the pulse width of the common drive waveform, based on the waveform rank.

The invention described in claim 3 is the droplet ejection apparatus according to claim 2, wherein the adjustment section expands or contracts an amplitude width of the common drive waveform, based on the waveform rank.

The invention described in claim 4 is the droplet ejection apparatus according to claim 3, wherein the adjustment section expands or contracts the drive pulses at an equal ratio.

The invention described in claim 5 is the droplet ejection apparatus according to any one of claims 1 to 4, wherein in the common drive waveform, at least an amplitude width of a waveform at switching between different droplet sizes is 18 V/μs or greater.

The invention described in claim 6 is the droplet ejection apparatus according to any one of claims 1 to 4, wherein the plurality of ejection drive pulses includes at least four drive pulses.

The invention described in claim 7 is a method of driving a droplet ejection apparatus that includes a droplet ejection head that ejects droplets having multiple sizes from a nozzle by using a common drive waveform and thereby performs a recording operation on a recording medium, the common drive waveform including multiple drive pulses in a drive cycle, the method including: an acquisition step of acquiring a distance between the recording medium and the droplet ejection head; an adjustment step of expanding or contracting a pulse width of the common drive waveform, based on the distance; a determination step of selecting one or more drive pulses corresponding to a droplet size from multiple drive pulses in the common drive waveform adjusted by the adjustment step and determining a plurality of ejection drive pulses; and an ejection control step of causing the nozzle to eject the droplets having multiple sizes by the plurality of ejection drive pulses determined by the determination step.

### Advantageous Effects of Invention

According to the present invention, even if the media gap changes, the landing positions of droplets having different sizes can be aligned.

### BRIEF DESCRIPTION OF DRAWINGS

FIG. 1 This is a perspective view of an inkjet recording apparatus.

FIG. 2 This is a block diagram of the inkjet recording apparatus.

FIG. 3 This is a schematic diagram of a pressure chamber and a nozzle as viewed in the axis direction of the nozzle and shows a change in the pressure chamber corresponding to a drive pulse.

FIG. 4 This is a flowchart illustrating a method of driving the inkjet recording apparatus according to the present embodiment.

FIG. 5 This is a diagram illustrating a media gap.

FIG. 6 This is a table showing the correspondence between media gaps and Length ranks.

FIG. 7A This is a diagram illustrating one common drive waveform before adjustment control is performed.

FIG. 7B This is a diagram illustrating a plurality of common drive waveforms on which adjustment control corresponding to the Length rank has been performed. FIG. 8A This is a graph of the droplet ejection speed when the amplitude width of the waveform at the switching of different droplet sizes is 12 V/μs.

FIG. 8B This is a graph of the droplet ejection speed when the amplitude width of the waveform at the switching of different droplet sizes is 14 V/μs.

FIG. 8C This is a graph of the droplet ejection speed when the amplitude width of the waveform at the switching of different droplet sizes is 18 V/μs.

FIG. 8D This is a graph of the ejection speed difference between the small droplet and the large droplet for each amplitude width of the waveform at the switching of different droplet sizes.

FIG. 9A This is a graph of the droplet ejection speed when three drive pulses are used to eject a single dot.

FIG. 9B This is a graph of the droplet ejection speed when four drive pulses are used to eject a single dot.

FIG. 9C This is a graph of the ejection speed difference between a small droplet and a medium droplet for each number of drive pulses used to eject a single dot.

FIG. 10 This is a diagram illustrating a plurality of common drive waveforms on which adjustment control corresponding to the Amplifier rank has been executed.

### DESCRIPTION OF EMBODIMENTS

An embodiment of the present invention will be described below with reference to the drawings. The following description exemplifies one embodiment of the present invention and does not limit the present invention.

### Overall Configuration of Inkjet Recording Apparatus

First, as a droplet ejection apparatus according to the present embodiment, a configuration example of an inkjet recording apparatus 1 including an inkjet head 23 as a droplet ejection head will be disclosed.

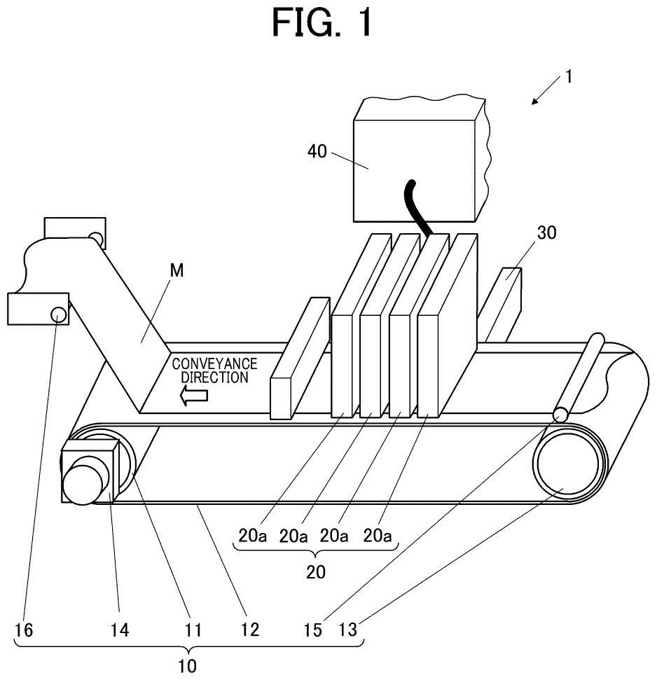

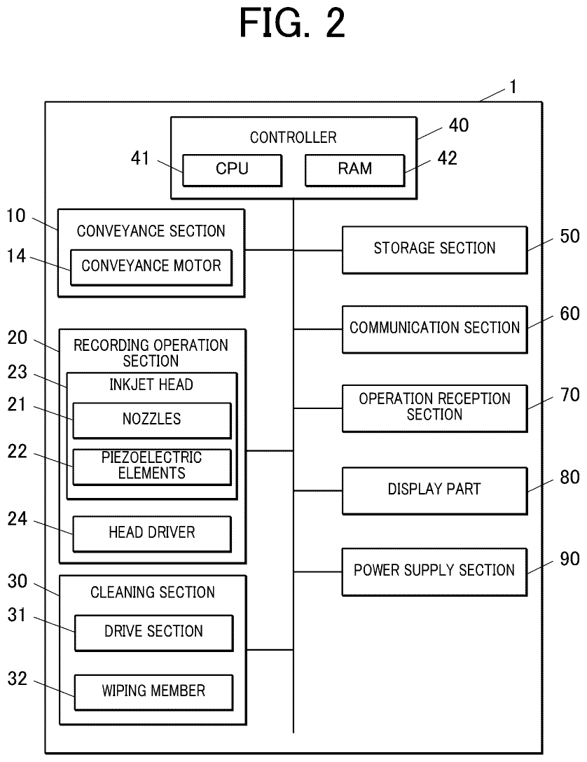

FIG. 1 is a perspective view of an inkjet recording apparatus 1. FIG. 2 is a block diagram illustrating the functional configuration of the inkjet recording apparatus 1. The inkjet recording apparatus 1 includes, for example, a conveyance section 10, a recording operation section 20, a cleaning section 30, a controller 40, a storage section 50, a communication section 60, an operation reception section 70, a display part 80, and a power supply unit 90.

### Conveyance Section

The conveyance section 10 moves a recording medium M on which an image is to be recorded. The recording medium M is not limited to a specific medium. As the recording medium M, textiles continuous in the conveyance direction or sheets are used, for example. The conveyance section 10 causes the recording medium M to face the recording range of the recording operation section 20.

The conveyance section 10 includes a drive roller 11, a conveyance belt 12, a driven roller 13, a conveyance motor 14, a pressing roller 15, and a peeling roller 16.

The conveyance belt 12 is an endless belt and is stretched between the drive roller 11 and the driven roller 13. The conveyance belt 12 rotates in accordance with rotation of the drive roller 11. With the rotation of the conveyance belt 12, the recording medium M placed on the conveyance surface moves in the conveyance direction in FIG. 1.

The driven roller 13 rotates with the movement of the conveyance belt 12. The conveyance motor 14 rotates the drive roller 11 at a rotational speed corresponding to a control signal from the controller 40. The roller 15 removes lifting from the placement surface, such as wrinkling. Specifically, the roller 15 presses the recording medium M on the placement surface of the conveyance belt 12 against the placement surface. The peeling roller 16 peels the recording medium M from the conveyance surface and sends the recording medium M to a post-processing device. Specifically, the roller 16 pulls the recording medium M from the conveyance belt 12 with a predetermined pressure.

### Recording Operation Section

The recording operation section 20 ejects ink droplets onto the recording medium M to record an image. The recording operation section 20 includes head units 20a disposed along the conveyance direction of the recording medium M. Each of the head units 20a includes a plurality of inkjet heads 23 that are arranged in a predetermined pattern and that eject ink droplets from openings. The inkjet head 23 includes nozzles 21 and piezoelectric elements 22.

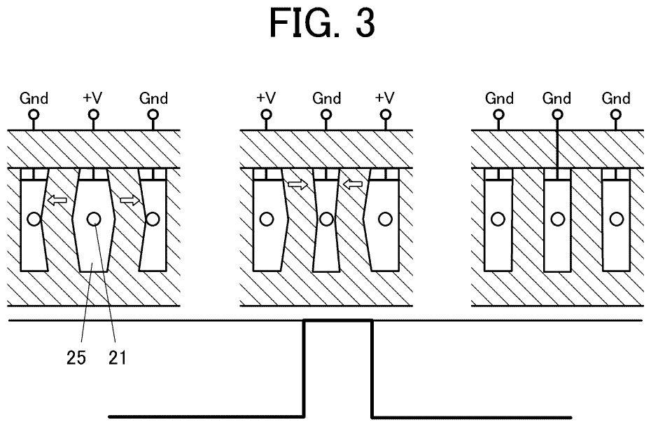

The recording operation section 20 includes a head drive section 24. The head drive section 24 outputs drive pulses for expanding or contracting each piezoelectric element 22 under the control of the controller 40. As illustrated in FIG. 3, the piezoelectric element 22 deforms an ink channel (pressure chamber) 25 that supplies ink to the nozzle 21 by being deformed by the drive pulse. The ink in the ink channel 25 is imparted with a pressure variation by the deformation and is ejected from the nozzle 21.

### Cleaning Section

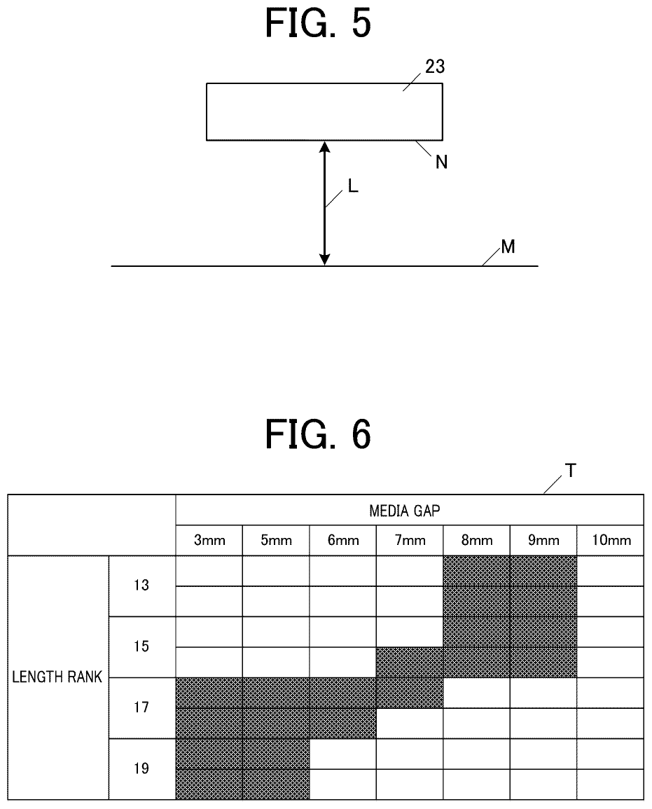

The cleaning section 30 cleans a nozzle surface N (see FIG. 5) of the inkjet head 23 on which the openings of the nozzles 21 are arranged. The cleaning section 30 includes, for example, a wiping member 32 that wipes ink or a solidified substance thereof adhering to the nozzle surface N, and a drive section 31 that operates the wiping member 32. The wiping member 32 is not limited to a specific member, but is, for example, a nonwoven fabric that absorbs ink or a blade-like resin member that scrapes off a solid.

### Controller

The controller 40 is a processor that centrally controls the entire operation of the inkjet recording apparatus 1. The controller 40 includes, for example, a central processing unit (CPU) 41 and a random-access memory (RAM) 42. The CPU 41 performs arithmetic operations to perform various kinds of control processing of the inkjet recording apparatus 1. The RAM 42 provides a working memory space for the CPU 41 and stores temporary data. The controller 40 functions as an adjustment section, a determination section, and an ejection controller by executing a predetermined program.

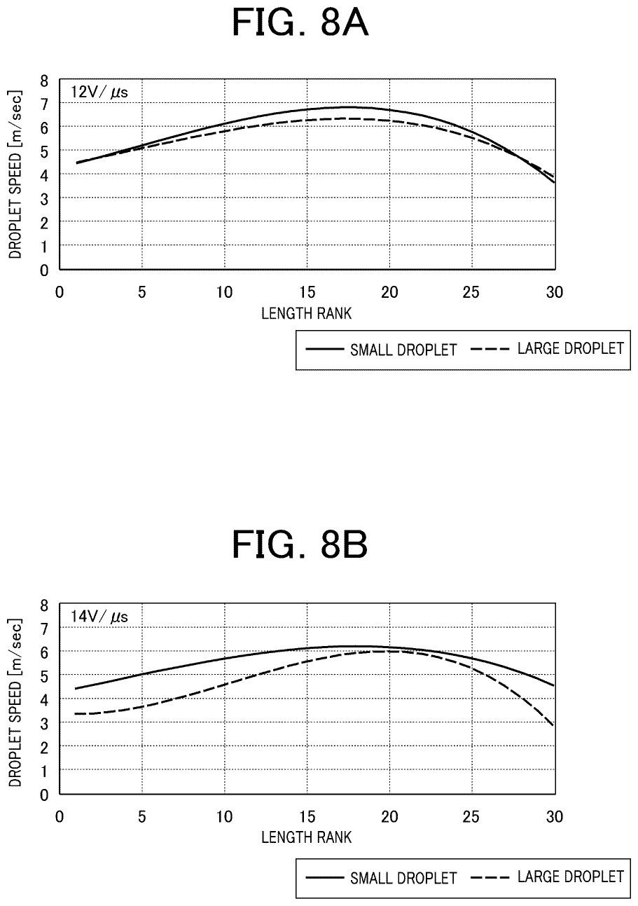

The controller 40 as the adjustment section adjusts the waveform of the common drive waveform P00 (see FIG. 7A). Details of the common drive waveform P00 and the adjustment control will be described later.

The controller 40 as the determination section generates a waveform selection signal. The waveform selection signal selects a drive pulse corresponding to the dot size from the common drive waveform P01 (see FIG. 7B) and determines ejection drive pulses for ejecting ink from the nozzle 21.

Specifically, the waveform selection signal is a negative logic pulse signal. When the controller 40 takes the logical sum of the negative logic pulse signal and the common drive waveform P01, the drive pulses other than the selected drive pulse are removed, and the ejection drive pulses are determined.

The controller 40 as the ejection controller causes the head drive section 24 to output the determined ejection drive pulses to the piezoelectric element 22. The controller 40 then causes the nozzle 21 to eject ink.

### Storage Section

The storage section 50 stores image data to be recorded, processed data of the image data, other setting data, and programs. The image data is stored in, for example, a dynamic random-access memory (DRAM) that can temporarily store a large amount of data and output the data at high speed. The setting data and programs are stored in a non-volatile memory, such as a flash memory, and/or a hard disk drive (HDD). With the above-described configuration, the setting data can be stored even in a situation where the power supply to the inkjet recording apparatus 1 is stopped.

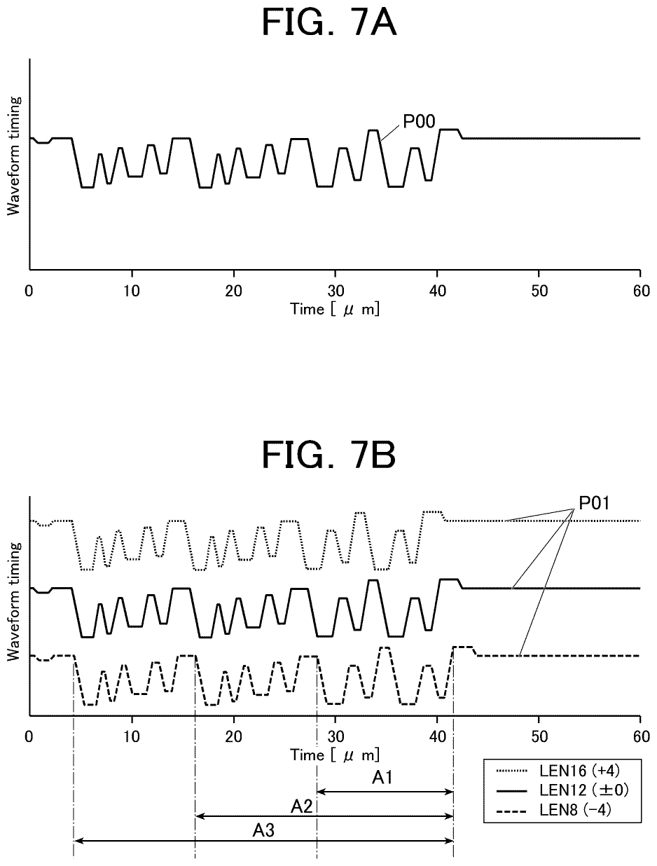

The storage section 50 stores the common drive waveform P00 before the adjustment control by the controller 40 and the common drive waveform PO1 after the adjustment control. The storage section 50 also stores a correspondence table T (refer to FIG. 6) showing the correspondence between the media gap and the Length rank (waveform rank) that are necessary for the controller 40 to execute the adjustment control.

### Communication Section

The communication section 60 controls transmission and reception of data with an external device in accordance with a predetermined communication standard, for example, the Transmission Control Protocol/Internet Protocol (TCP/IP). The communication section 60 may be connected to a local area network (LAN) and connectable to the external Internet via a router. The communication section 60 may be directly connectable to a peripheral device via a universal serial bus (USB) cable connected to a USB terminal.

### Operation Reception Section

The operation reception section 70 receives an input operation by a user and outputs the received content to the controller 40 as an input signal. The operation reception section 70 includes, for example, a touch screen or a push button switch. When the operation reception section 70 is a touch screen, the operation reception section 70 may be laid on the display screen of the display part 80, and the operation content may be specified in synchronization with the display content on the display screen.

### Display Part

The display part 80 displays statuses and a selection menu for the user. The display part 80 includes, for example, a display screen and an indicator (lamp). The indicator is used to indicate whether power supply is received or whether an operation abnormality occurs with a light emitting diode (LED) lamp, for example. The display part 80 includes, for example, a liquid crystal display and can display various letters and figures in a dot matrix on the display screen.

### Power Supply Section

The power supply section 90 supplies power from a power source to the inkjet recording apparatus 1.

### Drive Process in Recording Operation

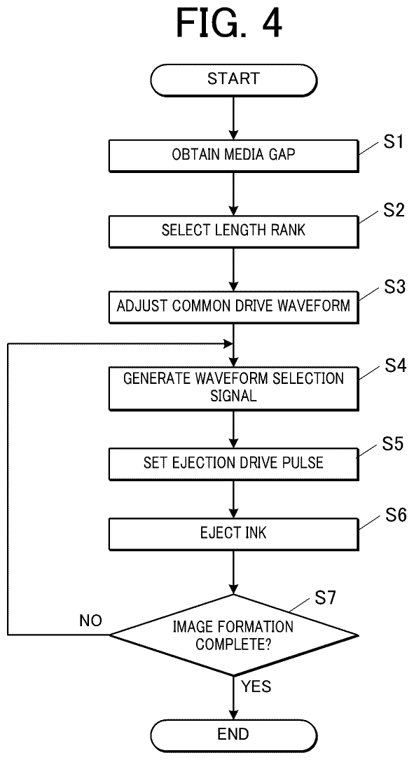

Next, a drive process of driving the inkjet head 23 in the recording operation will be described with reference to FIG. 4. The controller 40 of the inkjet recording apparatus 1 executes the drive process for the inkjet head 23 in response to obtaining a print instruction made by the user operating the operation reception section 70, for example.

### Media Gap Acquisition Step

First, the controller 40 acquires the media gap (step S1). As shown in FIG. 5, the media gap refers to the distance L from the nozzle surface N of the inkjet head 23 to the image forming surface of the recording medium M.

Specifically, for example, the storage section 50 stores in advance the media gap for each type of the recording medium M. The controller 40 acquires the media gap, based on the type of the recording medium M included in the print instruction. For another example, a device (distance sensor) capable of measuring the media gap from the recording medium M may be provided upstream of the inkjet head 23 in the conveyance direction. The controller 40 acquires the media gap based on the measurement data of the device. By the above-described control, the controller 40 functions as the acquisition section that acquires the distance L between the recording medium M and the droplet ejection head 23.

### Length Rank Selection Step

Next, the controller 40 selects a Length rank (step S2).

As described above, the storage 50 stores the correspondence table T of the media gap and the length rank. The controller 40 selects a Length rank that corresponds to the media gap acquired in step S1. By the above-described control, the controller 40 functions as the selection section that selects a waveform rank, based on the media gap.

FIG. 6 shows an example of the correspondence table T. As illustrated in FIG. 6, in the correspondence table T, the media gap and the Length rank are associated such that the greater the media gap is, the smaller the Length rank is. Therefore, in the adjustment control to be described later, the greater the media gap becomes, the wider the pulse width becomes.

The correspondence table T can be created by ejecting droplets having different sizes while changing the media gap and the length rank and by recording the media gap and the length rank with which the ejection positions are aligned, for example.

### Common Drive Waveform Adjustment Step

After selecting the Length rank, the controller 40 executes the adjustment control to adjust the waveform of the common drive waveform P00, based on the selected Length rank (step S3).

Specifically, as shown in FIG. 7A and FIG. 7B, the controller 40 expands or contracts the pulse widths of the drive waveform of the common drive waveform P00 in the time direction with the same expansion/contraction ratio, based on the Length rank. Thus, the controller 40 adjusts the common drive waveform P00 to the common drive waveform P01. In FIG. 7A and FIG. 7B, the common drive waveform PO1 for the Length rank of 12 is not deformed from the common drive waveform P00. In this case, it is also regarded that the adjustment control has been executed.

The subsequent operation is the same as the operation by a conventional inkjet recording apparatus 1. That is, the controller 40 generates a waveform selection signal for forming a dot of a desired size (step S4). Next, the controller 40 takes the logical sum of the common drive waveform PO1 and the waveform selection signal to select one or more drive pulses to be used for ink ejection from the group of drive pulses. Thus, the controller 40 determines the ejection drive pulses (step S5).

Specifically, as shown in FIG. 7B as an example, when the Length rank is 8 and a small droplet is to be ejected, the controller 40 takes the logical sum of the range indicated by the arrow A1 and the common drive waveform P01, for example. When a medium droplet is to be ejected, the controller 40 takes the logical sum of the range indicated by the arrow A2 and the common drive waveform P01, for example. When a large droplet is to be ejected, the controller 40 takes the logical sum of the range indicated by the arrow A3 and the common drive waveform P01, for example.

Next, the controller 40 causes the head drive section 24 to apply the selected drive pulses to the piezoelectric element 22, thereby causing the nozzle 21 to eject ink (step S6). The controller 40 repeatedly executes step S4 to step S6 until image formation according to the acquired print instruction is completed.

### EXAMPLE

Next, the results of evaluating the preferred configuration of the present invention will be described. Hereinafter, the present invention will be specifically described based on examples and so forth. The present invention is not limited to the following specific examples. In the following examples, a droplet less than 10 pl is defined as a small droplet; a droplet equal to or greater than 10 pl and less than 20 pl is defined as a medium droplet; a droplet greater than 20 pl is defined as a large droplet.

### Example 1. Relation Between Slope of Waveform at Switching of Droplet Sizes and Droplet Ejection Speed

Under the control of the controller 40, the amplitude width of the waveform at the switching between different droplet sizes in the common driving waveform P01 was set appropriately. With such an inkjet recording apparatus 1, the droplet ejection speed was measured while changing the Length rank for each droplet size.

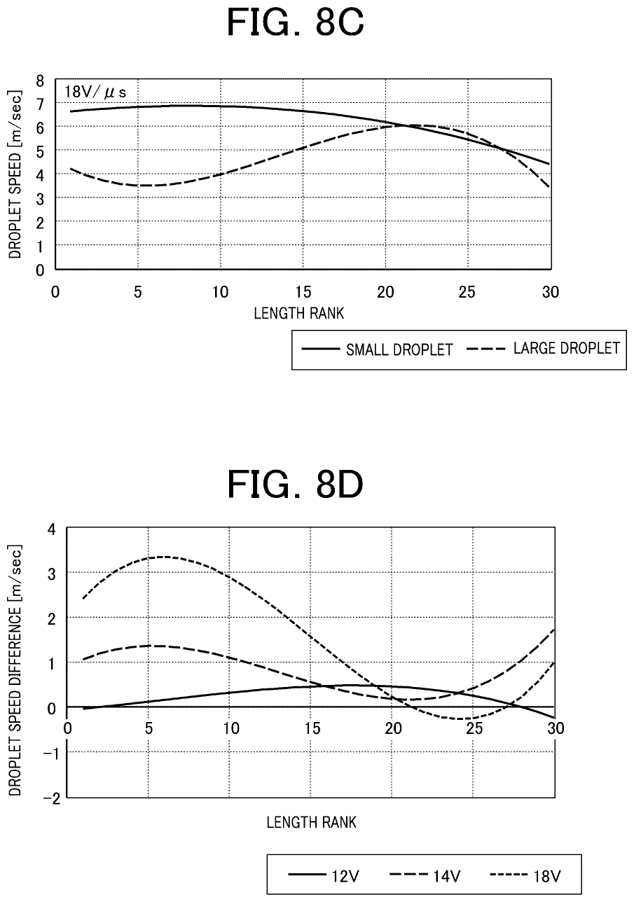

FIG. 8A is a graph illustrating the relation between the Length rank and the droplet ejection speed when the amplitude width of the waveform at the switching between different droplet sizes was set to 12 V/μs. FIG. 8B is a graph illustrating the relation between the Length rank and the droplet ejection speed when the amplitude width of the waveform at the switching between different droplet sizes was set to 14 V/μs. FIG. 8C is a graph illustrating the relation between the Length rank and the droplet ejection speed when the amplitude width of the waveform at the switching between different droplet sizes was set to 18 V/μs. In FIG. 8A to FIG. 8C, the horizontal axis represents the length rank, and the vertical axis represents the droplet ejection speed. FIG. 8D is a graph illustrating differences in droplet ejection speeds between a small droplet and a large droplet for each length rank at each amplitude width, based on FIG. 8A to FIG. 8C. In FIG. 8D, the horizontal axis represents the length rank, and the vertical axis represents the droplet ejection speed difference.

As can be seen from comparison of FIG. 8A, FIG. 8B and FIG. 8C, or from FIG. 8D, when droplets having different sizes are ejected and when the amplitude width of the waveform at the switching of different droplet sizes is 18 V/μs or greater, a difference in droplet speed occurs.

### Example 2. Relation Between Number of Drive Pulses for Ejecting One Dot and Ejection Speed for Each Droplet Size

Under the control of the controller 40, the inkjet recording apparatus 1 was set to eject one dot of droplet by three drive pulses. With such an inkjet recording apparatus 1, the droplet ejection speed was measured while changing the Length rank for each droplet size. Similarly, the inkjet recording apparatus 1 was set to eject one dot of droplet by four drive pulses. Then, the droplet ejection speed was measured while changing the Length rank for each droplet size.

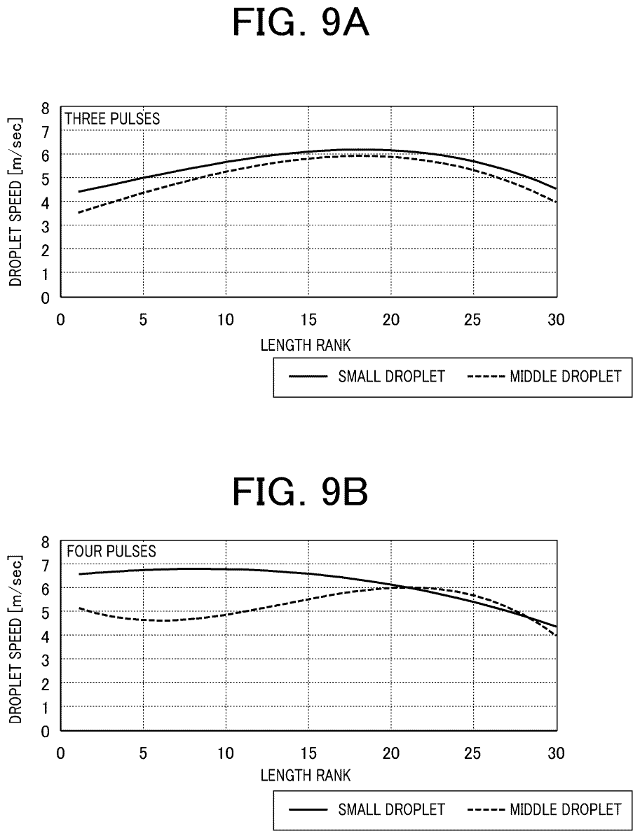

FIG. 9A is a graph of the droplet ejection speed when one dot of droplet is ejected by three drive pulses. FIG. 9B is a graph of the droplet ejecting speed when one dot of droplet is ejected by four drive pulses. In FIG. 9A and FIG. 9B, the horizontal axis represents the length rank, and the vertical axis represents the droplet ejection speed. FIG. 9C is a graph illustrating differences in droplet ejection speeds between a small droplet and a medium droplet for each Length rank at each number of drive pulses, based on FIG. 9A and FIG. 9B. In FIG. 9C, the horizontal axis represents the length rank, and the vertical axis represents the difference in droplet ejection speeds.

As can be seen from comparison between FIG. 9A and FIG. 9B or from FIG. 9C, when one dot of droplet is ejected by four or more drive pulses, a difference in droplet speed occurs when droplets having different sizes are ejected.

### Summary

As described above as the examples 1 and 2, when the amplitude width of the waveform at the switching between different droplet sizes is 18 V/μs or greater, and when one dot of droplet is ejected by four or more drive pulses, the ejection speed differs among different droplet sizes. As a result, landing unevenness tends to occur. According to the inkjet recording apparatus 1 of the present embodiment, such a difference in ejection speed among droplet sizes can be resolved by selecting the Length rank.

### Effects of Embodiment

As described above, the inkjet recording apparatus 1 according to the present embodiment includes the acquisition section that acquires the distance L between the recording medium M and the inkjet head 23. The inkjet recording apparatus 1 further includes the adjustment section that expands or contracts the pulse width of the common drive waveform P00, based on the distance L. The inkjet recording apparatus 1 further includes the determination section that determines the ejection drive pulses by selecting one or more drive pulses corresponding to the size of the droplet from the adjusted common driving waveform P01. The inkjet recording apparatus 1 further includes the ejection controller that causes the nozzle 21 to eject droplets having multiple sizes by using the ejection drive pulses determined by the determination section. As described above, even when the media gap of the recording medium M changes, the inkjet recording apparatus 1 adjusts the common drive waveform P00 according to the change. Therefore, according to the inkjet recording apparatus 1 of the present embodiment, even when the media gap of the recording medium M changes, the landing positions of droplets having different sizes can be aligned.

In the inkjet recording apparatus 1 according to the present embodiment, the adjustment section expands or contracts the drive pulses at an equal ratio. The determination section determines, from the common drive waveforms, the ejection drive pulses for ejecting droplets having multiple sizes. According to such a configuration, the adjustment section can finely adjust the pulse width and the amplitude width of the common drive waveform P00.

In the inkjet recording apparatus 1 according to the present embodiment, at least the amplitude width of the waveform of the common driving waveform P00 at the switching between different droplet sizes is equal to or greater than 18 V/μs. In the inkjet recording apparatus 1 according to the present embodiment, the ejection drive pulses include at least four drive pulses. As described above, in such a configuration, the ejection speed difference among droplet sizes becomes greater. However, according to the inkjet recording apparatus 1 of the present embodiment, the landing positions can be aligned.

### Other Configurations

Although the present invention has been described in detail based on the embodiment, the present invention is not limited to the above-described embodiment. The present invention can have various modifications including the scope of the invention described in the scope of the claims and the equivalent thereof.

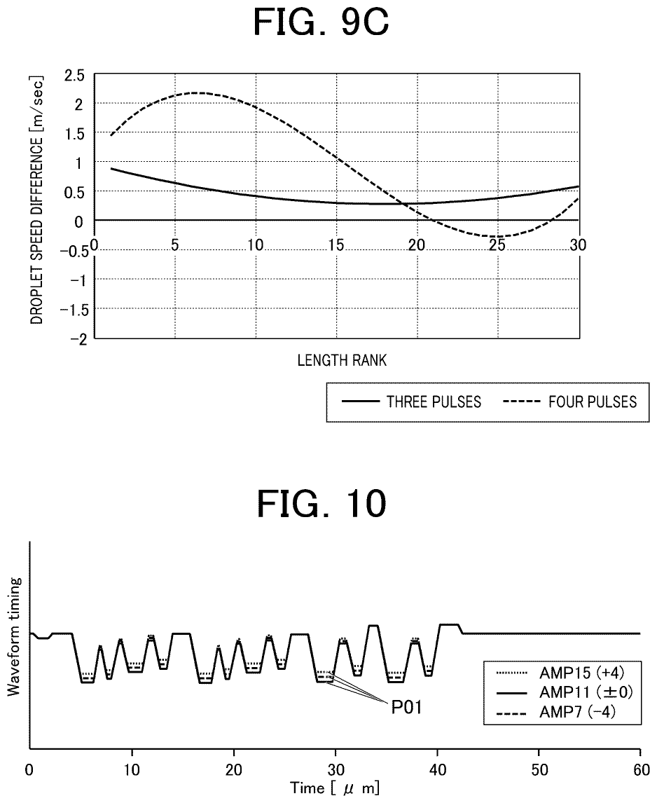

In the above description, the landing positions are adjusted by changing only the pulse width of the common driving waveform P00. However, the invention is not limited thereto. For example, as illustrated in FIG. 10, the landing positions may be adjusted by changing the amplitude width (drive voltage value) of the common drive waveform P00.

The changes are made based on the Amplifier ranks (waveform rank) corresponding to the media gaps. However, changing the amplitude width causes a small change amount in the landing position. It is therefore preferable that the pulse width of the common drive waveform P00 is changed and thereafter the drive voltage value is changed for fine adjustment.

In the above description, the landing positions are adjusted for one inkjet head 23. The present invention is also applicable to the inkjet recording apparatus 1 including a plurality of inkjet heads 23. In such a configuration, different correspondence tables T may be set for the respective inkjet heads 23, based on the individual differences.

The droplet ejection speed also changes according to the viscosity, surface tension, density, and other physical properties of the ink to be ejected. For example, ink containing large particles having a relatively small specific gravity has a low density, so that the degree of decrease in the ejection speed becomes large. Therefore, the correspondence table T may be prepared for each physical property of ink to be ejected.

In the above description, the controller 40 acquires the length rank based on the media gap by referring to the correspondence table and adjusts the common drive waveform P00. However, the present invention is not limited thereto. For example, the controller 40 may adjust the common drive waveform P00 from the media gap, based on a predetermined function.

In the above description, the controller 40 automatically acquires the media gap and the length rank. However, the present invention is not limited thereto. For example, the medium gap, the range of the droplet size, and the Length rank may be input by the user operating the operation reception section 70 and received.

FIG. 7B shows the case where the controller 40 takes the logical sum of the common drive waveform P01 and the waveform selection signal according to the droplet size from the rear end side of the common drive waveform P01 in the time direction. However, the invention is not limited thereto. For example, the controller 40 may take the logical sum of the common drive waveform P01 and the waveform selection signal according to the droplet size from the front end side of the common drive waveform P01 in the time direction. For another example, the controller 40 may not take the logical sum of the common drive waveform P01 and the waveform selection signal, based on any reference position of the common drive waveform P01.

In the above description, the droplet ejection apparatus is the inkjet recording apparatus 1. However, the droplets ejected by the droplet ejection apparatus are not limited to ink droplets. For example, the droplet ejection apparatus may eject droplets of various functional liquids, such as a pretreatment agent.

### INDUSTRIAL APPLICABILITY

The present invention is applicable to: a droplet ejection apparatus that aligns landing positions of droplets having different sizes even when the medium gap changes; and a method of driving the droplet ejection apparatus.

### REFERENCE SIGNS LIST

1 Inkjet recording apparatus (droplet ejection apparatus)
21 Nozzle
23 Inkjet head (droplet ejection head)
40 Controller (acquisition section, selection section, adjustment section, determination section, ejection controller)
L distance (media gap, distance between recording medium and droplet ejection head)
M Recording medium
T Correspondence table (table)
P00 Common drive waveform
P01 Common drive waveform (adjusted common drive waveform)

1. A droplet ejection apparatus comprising:
a droplet ejection head that ejects droplets having multiple sizes from a nozzle by using a common drive waveform and thereby performs a recording operation on a recording medium, the common drive waveform including multiple drive pulses in a drive cycle; and
a hardware processor that:
acquires a distance between the recording medium and the droplet ejection head;
adjusts the common drive waveform by expanding or contracting a pulse width of the common drive waveform, based on the distance;
selects one or more drive pulses corresponding to a droplet size from the adjusted common drive waveform-adjusted and determines a plurality of ejection drive pulses; and
causes the nozzle to eject the droplets having multiple sizes by the determined plurality of ejection drive pulses section.

2. The droplet ejection apparatus according to claim 1, wherein the hardware processor selects a waveform rank, based on a table in which the waveform rank is associated with the distance, and
expands or contracts the pulse width of the common drive waveform, based on the waveform rank.

3. The droplet ejection apparatus according to claim 2, wherein the hardware processor expands or contracts an amplitude width of the common drive waveform, based on the waveform rank.

4. The droplet ejection apparatus according to claim 3, wherein the hardware processor expands or contracts the drive pulses at an equal ratio.

5. The droplet ejection apparatus according to claim 1, wherein in the common drive waveform, at least an amplitude width of a waveform at switching between different droplet sizes is 18 V/μs or greater.

6. The droplet ejection apparatus according to claim 1, wherein the plurality of ejection drive pulses includes at least four drive pulses.

7. A method of driving a droplet ejection apparatus that includes a droplet ejection head that ejects droplets having multiple sizes from a nozzle by using a common drive waveform and thereby performs a recording operation on a recording medium, the common drive waveform including multiple drive pulses in a drive cycle, the method comprising:
acquiring a distance between the recording medium and the droplet ejection head;
adjusting the common drive waveform by expanding or contracting a pulse width of the common drive waveform, based on the distance;
selecting one or more drive pulses corresponding to a droplet size from multiple drive pulses in the adjusted common drive waveform and determining a plurality of ejection drive pulses; and
causing the nozzle to eject the droplets having multiple sizes by the determined plurality of ejection drive pulses.
